(19) United States
(12) Patent Application Publication
(10) Pub. No.: US 2014/0118635 A1
(43) Pub. Date: May 1, 2014

(54) TOUCH SCREEN HAVING MESH PATTERNED ELECTRODES

(71) Applicant: Heui Bong Yang, Gumi-si (KR)

(72) Inventor: Heui Bong Yang, Gumi-si (KR)

(21) Appl. No.: 13/995,547

(22) PCT Filed: Apr. 11, 2013
(86) PCT No.: PCT/KR2013/003031

§ 371 Date: Jun. 19, 2013

(30) Foreign Application Priority Data
Jun. 11, 2012 (KR) 10-2012-0062112

(51) Int. Cl. G06F 1/16

(52) U.S. Cl. CPC G06F 1/1692
USPC 349/12

(57) ABSTRACT

A touch screen having mesh patterned electrodes in accordance with an embodiment of the present invention includes: a plurality of first electrode lines formed with metal lines in a diagonal direction on one surface of a transparent layer; and a plurality of second electrode lines formed with metal lines on the same surface as the plurality of first electrode lines and intersecting with the first electrode lines—wherein any one electrode line of the first electrode lines and the second electrode lines forms a severed area where the plurality of first electrode lines intersect with the plurality of second electrode lines in such a way that the first electrode lines are electrically severed from the second electrode lines, and wherein the other electrode line of the first electrode lines and the second electrode lines passes through the severed area, and a step is formed at a position facing the severed area; and a connection pattern electrically connecting the electrode lines severed by the severed area.

### BACKGROUND

1. Technical Field

The present invention relates to a touch screen, more specifically to a touch screen having mesh patterned electrodes formed on one layer thereof using an access pattern at a portion where electrode lines intersect.

2. Background Art

Portable terminals, such as smartphones, Internet devices and handheld game consoles, increasingly require slimmer external appearances for improved portability by users.

Since it is inconvenient for the users to perform desired functions using menu keys, number keys and navigations keys due to the limited size of these portable terminals, these portable terminals are configured to allow the users to view and directly select the menu displayed on the screen using a touch screen.

Since the touch screen allows the users to view the screen and perform desired functions by touching the menu displayed on the screen, the touch screen needs to be made of a transparent material and include touch electrodes for sensing the touch input of the users.

The touch electrodes are commonly constituted with two electrode lines having an intersecting structure in the touch screen, and the two touch electrode lines are formed in individual sheets, respectively, which are overlapped and arranged on a cover glass, making it possible to determine a touch input by the user.

The lattice structure of touch screen uses a capacitive method, and the plurality of first conductive-side lines and second conductive-side lines form a pattern of sensor electrodes. When an object approaches this lattice structure of touch screen, the capacitance that is changed at the position of approach is collected by the first and second conductive-side lines that are connected in latitudinal and longitudinal directions, respectively. The touch input is detected by analyzing the collected signal.

Since the touch screen needs to be formed with a transparent material in order to project a screen displayed by a display device, the two individual sheets having a cross structure need to be also made of a transparent material.

For the electrodes of the touch screen, a light-permeable conductor, such as ITO (Indium Tin Oxide), which has a greater electrical resistance than conductive metals but has a greater optical permeability, is used.

The light-permeable conductor is commonly formed on a PET film and can be hardly made to be big because surface damage and anion impact occur in proportion to the stacking time when a thin film is produced.

For problems of using a light-permeable conductor such as ITO, U.S. Patent Publication Number US 2010/0156840 has disclosed a touch screen sensor that detects a touch input by use of a mesh structure of touch electrodes.

In the touch screen sensor suggested by US 2010/0156840, electrode sheets having X-axis touch electrodes and Y-axis touch electrodes, which are made of an opaque metallic material, individually are overlapped to constitute a touch panel so as to detect a touch input by a user.

As electronic devices using a touch panel are increasingly required to be slimmer and capable of rendering finer images, there has been an increasing demand for a touch panel technology that can make a sheet layer, which constitutes the touch panel, thinner, increase the optical transparency of the sheet layer and reduce the number of manufacturing steps.

### SUMMARY

The present invention provides a touch screen in which a plurality of first and second electrode lines intersecting in a lattice form are formed in a single transparent layer, a severed area is formed at each area where the electrode lines intersect, and mesh patterned electrodes are formed in such a way that the plurality of first and second electrode lines are electrically demarcated using a connection pattern electrically connecting severed electrode lines.

The present invention also provides a touch screen having mesh patterned electrodes formed therein so that position information of a touch point can be detected, by forming sub-electrode lines inside the first and second electrode line, without using a light-permeable conductor layer such as ITO.

An embodiment of the present invention provides a touch screen having mesh patterned electrodes that includes a first electrode and a second electrode, intersecting with each other on an insulating transparent layer. The first electrode and the second electrode can be an alloy of at least one selected from the group consisting of gold, silver, platinum, copper, nickel and chrome.

The insulating transparent layer can be one selected from the group consisting of glass and PET, transparent film, transparent acryl and transparent plastic.

Moreover, a touch screen having mesh patterned electrodes in accordance with an embodiment of the present invention includes: a plurality of first electrode lines formed with metal lines in a diagonal direction on one surface of a transparent layer; and a plurality of second electrode lines formed with metal lines on the same surface as the plurality of first electrode lines and intersecting with the first electrode lines—wherein any one electrode line of the first electrode lines and the second electrode lines forms a severed area where the plurality of first electrode lines intersect with the plurality of second electrode lines in such a way that the first electrode lines are electrically severed from the second electrode lines, and wherein the other electrode line of the first electrode lines and the second electrode lines passes through the severed area, and a step is formed at a position facing the severed area; and a connection pattern electrically connecting the electrode lines severed by the severed area.

### BRIEF DESCRIPTION OF THE DRAWINGS

FIG. 1 illustrates a structure of electrodes in a touch screen that forms touch electrodes by using a connection pattern in accordance with an embodiment of the present invention.

FIG. 2 is a conceptual diagram for illustrating electrode lines shown in FIG. 1.

FIG. 3 is conceptual diagram for illustrating a structure of electrode lines and sub-electrode lines.

FIG. 4 is a detailed diagram of the connection pattern and the sub-electrode lines.

FIG. 5 and FIG. 6 are conceptual diagrams of the connection pattern in accordance with an embodiment of the present invention.

FIG. 7 is a conceptual diagram of the connection pattern in accordance with another embodiment of the present invention.

FIG. 8 and FIG. 9 are conceptual diagrams of the connection pattern in accordance with another embodiment of the present invention.

FIG. 10 is a lateral cross-sectional view illustrating the connection pattern shown in FIG. 5.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of the present invention, when describing a certain relevant conventional technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

A first electrode line and a second electrode line in accordance with an embodiment of the present invention are constituted with metallic materials. The first electrode line and the second electrode line can be made from gold, silver, platinum, copper, nickel, chrome and an alloy of at least one of these metals, but it is also possible that the first electrode line and the second electrode line are made from a metallic oxide having electric conductivity.

Moreover, it is possible that the first electrode line is made of a light-permeable conductor, such as ITO, and that the second electrode line is made from gold, silver, platinum, copper, nickel, chrome and an alloy of at least one of these metals.

Moreover, it is also possible that the first electrode line is made from gold, silver, platinum, copper, nickel, chrome and an alloy of at least one of these metals and that the second electrode line is formed by being combined with a light-permeable conductor, such as ITO.

Hereinafter, the present invention will be described in detail with reference to the accompanying drawings.

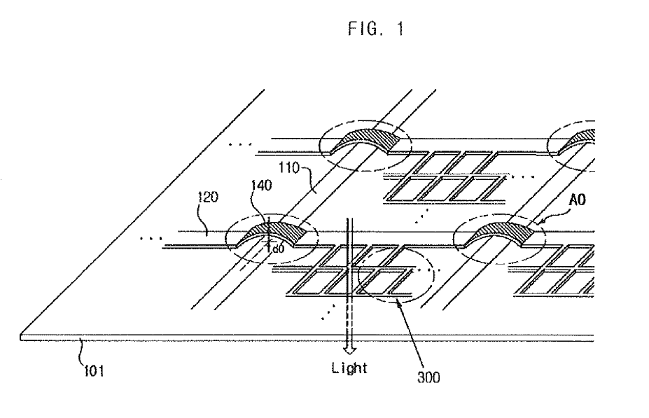

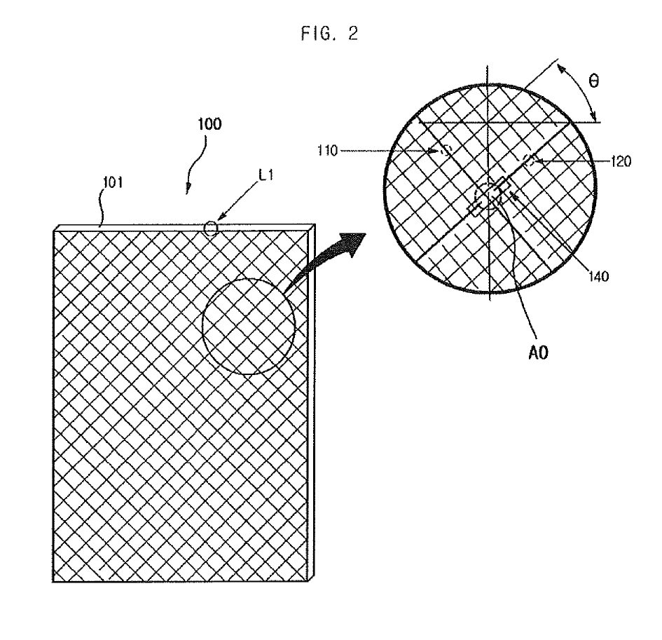

FIG. 1 illustrates a structure of electrodes of a touch screen 100 that forms touch electrodes using a bridge-type connection pattern in accordance with an embodiment of the present invention, and FIG. 2 illustrates a conceptual diagram of the touch electrodes shown in FIG. 1.

Referring to FIG. 1 and FIG. 2, a touch screen having mesh patterned electrodes in accordance with an embodiment of the present invention is formed with a plurality of first electrode lines 110 and a plurality of second electrode lines 120, which are metallic lines formed in diagonal directions on a same plane as a transparent layer 101.

The first electrode lines 110 and the second electrode line 120 form an intersecting structure, which is repeated to form an entire surface of the transparent layer 101 as a touch area.

The transparent layer in accordance with an embodiment of the present invention and refers to a layer which is constituted with glass, PET film and other transparent materials and in which the plurality of first electrode lines and the plurality of second electrode lines are formed.

Moreover, the transparent layer 101 in accordance with an embodiment of the present invention can refer to a layer which is constituted with glass or a non-conductive transparent material, for example, polymer such as PET or PEN and in which the plurality of first electrode lines and the plurality of second electrode lines are formed.

As shown in FIG. 2, an embodiment of the present invention has a structure in which the first electrode lines and the second electrode lines intersect with one another.

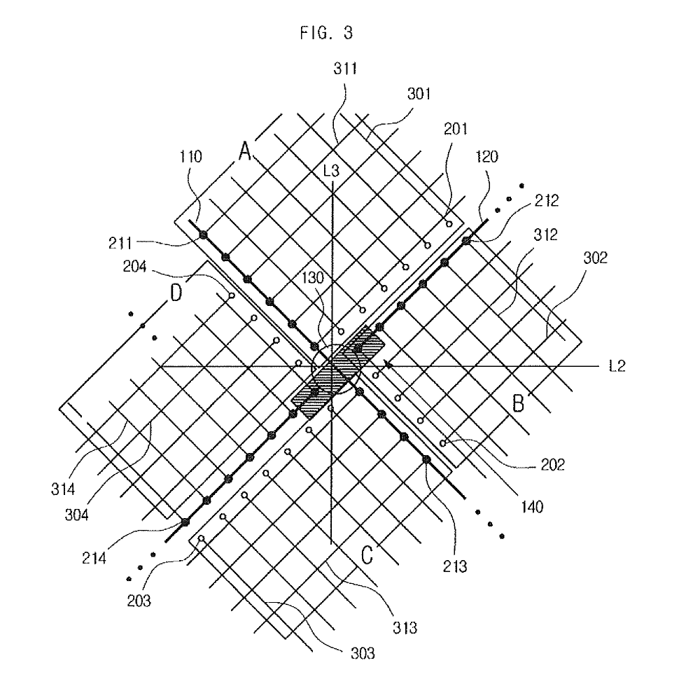

FIG. 3 is a conceptual diagram for illustrating a structure of touch electrodes and sub-electrodes.

Referring to FIG. 3, the plurality of first electrode lines 110 and second electrode lines 120 each have a plurality of sub-electrode lines 301, 311, 302, 312, 303, 313, 304, 314 formed therein.

As shown in FIG. 3, the plurality of sub-electrode lines associated with each of the electrode lines are arranged in a mesh structure.

The first electrode lines, the second electrode lines, the sub-electrode lines and bridge-type connection pattern can be constituted with a same material, but any one of the above may be made with a different material.

Referring to FIG. 2, one electrode line of the first electrode lines and the second electrode lines form a severed area where intersect with one another.

A bridge-type connection pattern 140, which forms a step d0 with another electrode line 110 is formed in a severed area A0 where the pattern is severed.

In an embodiment of the present invention, the second electrode lines 120 and the first electrode lines 110 can be each formed on a same plane as the transparent layer 101 by the severed area and the bridge-type connection pattern 140.

Accordingly, it is possible to form the touch screen 100 with one layer without overlapping a sheet including the plurality of electrode lines 110 and a sheet including the second electrode lines 120 on the transparent layer 101.

In an embodiment of the present invention, the pattern is formed to be severed in an area where the second electrode line 120 intersects with the first electrode line 110, and the step d0 from the first electrode line 110 is formed at a position facing the severed area A0, and the bridge-type connection pattern 140, which is an access pattern that electrically connects the electrode lines severed by the severed area, is formed.

In other words, the second electrode line passes through the severed area.

Then, in the severed area A0, where the pattern is severed, the bridge-type connection pattern 140, which forms the step d0 from the first electrode line 110, is formed.

The second electrode line 120 can independently transfer a signal to the first electrode line 110 and the same plane as the transparent layer 101 because of the severed area A0 and the bridge-type connection pattern 140.

In an embodiment of the present invention, the bridge-type connection pattern 140 can be realized in an arch form, which is provided in the severed area A0 for electrical insulation of the first electrode 110 and the second electrode 120, or in a thin film form, which has the step d0 from the first electrode line 110 and electrically connects the severed area A0.

For insulation between the bridge-type connection pattern 140 and the first electrode line, an insulation pattern can be inserted or an insulation pattern can be formed in the severed area A0.

As illustrated in FIG. 3, the first electrode lines 110 and the second electrode lines 120 can each include a plurality of sub-electrodes. For example, the second electrode lines 120 can have a plurality of sub-electrode lines 301, 311, which are connected in the form of a net, formed therein in a mesh structure to respond to a touch input by a user.

The sub-electrode lines 301, 302 have a form in which a center portion thereof is hollow and is formed in such a way that most of light emitted from a display device (e.g., an LED panel) is emitted to an outside.

In order to improve an optical permeability of the touch screen 100 in accordance with an embodiment of the present invention, the sub-electrode lines having the mesh structure need to be thinly formed.

In an embodiment of the present invention, the sub-electrode lines 301, 311 having the mesh structure can have a thickness of 0.05-10 um and a width of 0.5-10 um in order to provide transparency and reliability for the touch signal.

When the sub-electrode lines 301, 311 having the above thickness and width are repeatedly formed at every 100-200 um, the sub-electrode lines 301, 311 placed in the touch screen 100 are not easily visible by the user, most of the light emitted from the display device (e.g., an LED panel, an LCD panel, an organic EL panel, etc.) can be emitted toward the user.

When the display device and the touch screen 100 are used together, it is possible that moire is occurred by optical interference due to a difference of material and structure between the display device and the touch screen 100.

Ideally, a line connected perpendicularly from a crossing point of the first electrode line 110 and the second electrode line 120 forms a right angle with an upper-side line L1 of the touch screen 100, but moire can be prevented by tilting this line by a certain angle.

In an embodiment of the present invention, while the first electrode line 110 and the second electrode line 120 are perpendicular to each other, an acute angle (θ) formed by the second electrode line 120 and the upper-side line L1 is 25-65 degrees, in order to prevent the moire from occurring.

That is, according to experiments, the moire can be minimized by forming a mesh electrode in the form of tilting the line, drawn longitudinally from the crossing point of the first electrode line 110 and the second electrode line 120, by within 20 degrees to the left or right from a line perpendicularly formed from the upper-side line L1 of the touch screen 100.

The angle of tilt can be varied depending on the material and structure of the display device, and the moire can be minimized by adjusting the angle of tilt by within 0-20°.

FIG. 3 illustrates a conceptual diagram for the structure of the first and second electrode lines and the sub-electrode lines.

Referring to FIG. 3, as the first electrode line 110 and the second electrode line 120 cross with each other, areas around the first electrode line 110 and the second electrode line 120 can be divided into A to D areas.

The A area and the C area demarcated by the first electrode line 110 and the second electrode line 120 are connected to the first electrode line 110, and the B area and the D area demarcated by the first electrode line 110 and the second electrode line 120 are connected to the second electrode line 120.

Referring to FIG. 3, the sub-electrode lines 301, 311, 303, 313 that are formed in a lattice form in the A and C areas are connected 211 to the first electrode line 110 but are electrically severed 201 from the second electrode line. Moreover, the sub-electrode lines 302, 312, 304, 314 that are formed in a lattice form in a lattice form are connected 212, 214 to the second electrode line 120 but electrically severed 202, 204 from the first electrode line 110.

According to an embodiment of the present invention, the plurality of sub-electrodes that are demarcated by the first electrode line 110 and the second electrode line 120 and are formed in areas longitudinally facing one another are connected to the first electrode line 110 but are electrically severed from the second electrode line 120, and the plurality of sub-electrodes that are formed in areas latitudinally facing one another are connected to the second electrode line 120 but are electrically severed from the first electrode line 110.

Due to the above connection structure, a line segment L2 that connects the A area with the C area can perpendicularly intersect with a line segment L3 that connects the B area with the D area. When the illustrated line segments L2, L3 are repeatedly formed at regular intervals on the touch screen 100, the illustrated line segments L2, L3 can be used to instruct the touch input and position information to the first electrode line 110 and the second electrode line 120.

Meanwhile, in FIG. 3 in accordance with an embodiment of the present invention, the bridge-type connection pattern 140, which forms a step from the first electrode line 110, can be formed in an area where the second electrode line 120 and the first electrode line 110 intersect with each other, to electrically insulate the second electrode line 120 from the first electrode line 110.

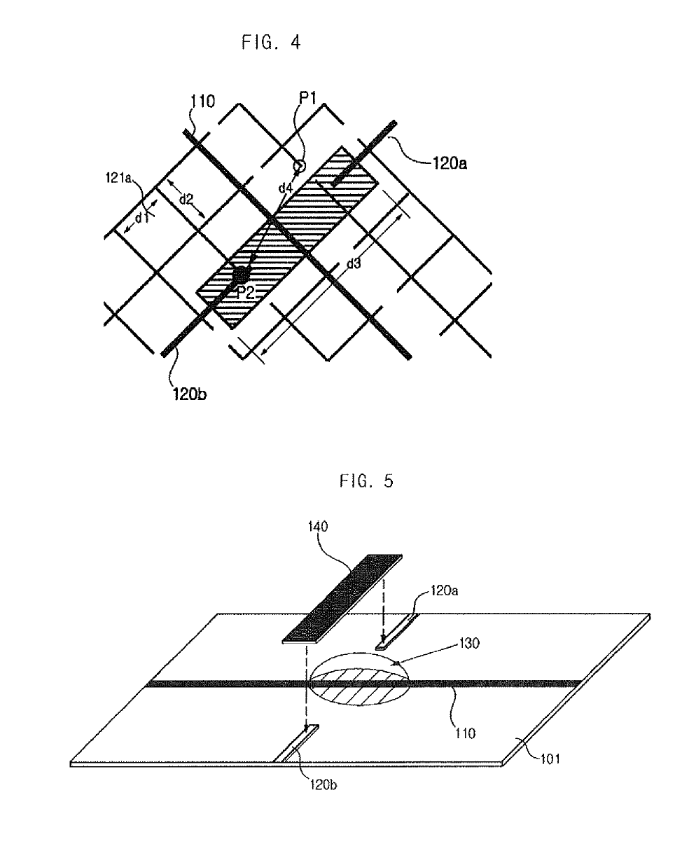

FIG. 4 is a detailed view of the bridge-type connection pattern and the sub-electrode line.

Referring to FIG. 4, with respect to the first electrode line 110, the sub-electrode line is connected P2 in the direction of a partial electrode 120b of the second electrode line 120, and the sub-electrode line is severed P1 in the direction of a partial electrode 120a.

In order to sever the first electrode line 110 and the second electrode line 120 from each other, the partial electrodes 120a, 120b of the second electrode line 120 intersecting with the first electrode line need to be separated from the first electrode line 110 by as much as a lattice of the sub-electrode.

Referring to FIG. 4, ends of the partial electrodes 120a, 120b neighboring the first electrode line 110 are separated from the first electrode line 110 by d2 and d1, respectively.

Accordingly, a major-axial length of the bridge-type connection pattern 140 connecting severed areas of the partial electrodes 120a, 120b needs to be greater than a sum of shortest distances d1, d2 between the ends of the partial electrodes 120a, 120b and the first electrode line 110. However, since the transmittance of the light emitted toward the touch screen 100 in accordance with an embodiment of the present invention can be lowered if the bridge-type connection pattern 140 is formed to be too long, and connectivity to the partial electrodes 120a, 120b can be lowered if the bridge-type connection pattern 140 is formed to be too short, it is preferable that the major-axial length of the bridge-type connection pattern 140 is greater than the sum of d1 and d2 but smaller than 4 times of the sub-electrode 121a.

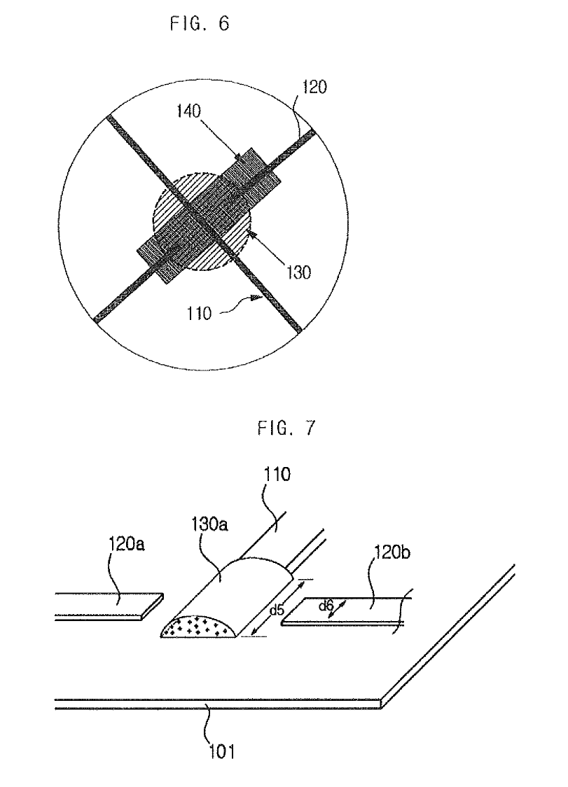

FIG. 5 and FIG. 6 are conceptual diagrams illustrating a bridge-type connection pattern in accordance with an embodiment of the present invention.

Referring to FIGS. 5 and 6, the first electrode line 110 and the second electrode line 120 intersect with each other on the transparent layer 101, and the second electrode line 120 can be divided into two partial electrodes 120a, 120b in the intersected area so that the second electrode line 120 is electrically severed from the first electrode line 110.

In an embodiment of the present invention, an insulation pattern 130 having a thickness of 0.5-2 um and a width of 1-100 um is coated in between the two partial electrodes 120a, 120b.

Used for the insulation pattern 130 can be a transparent resin or a clear insulation material with a good light transmittance, and the bridge-type connection pattern 140 is electrically connected to both ends of the partial electrodes 120a, 120b after the insulation pattern 130 is coated.

According to an embodiment of the present invention, the bridge-type connection pattern 140 can form an arch shape in an area through which the first electrode line 110 passes, depending on the way the insulation pattern 130 is coated.

A diameter of the insulation pattern 130 can be configured to be greater than a width of the bridge-type connection pattern 140, in order to provide insulation between the bridge-type connection pattern 140 and the first electrode line 110.

According to an embodiment of the present invention, if it is assumed that the width of the bridge-type connection pattern 140 is 50 um, the insulation pattern 130 has the diameter of 50-100 um.

FIG. 7 is a conceptual diagram illustrating the insulation pattern 130 in accordance with another embodiment of the present invention.

In another embodiment of the present invention, the insulation pattern 130 can be coated in such a way that the first electrode line 110 is not exposed. For example, if it is assumed that the width of the first electrode line is 2 um, the insulation pattern 130 can be coated in the width of 2-4 um, and the bridge-type connection pattern 140 can electrically connect the partial electrodes 120a, 120b with each other across an area where the insulation pattern 130 is coated.

Referring to FIG. 7, an insulation pattern 130a can be coated along a lengthwise direction of the first electrode line 110 to insulate the first electrode line 110, and connect both ends of the partial electrodes 120a, 120b to the bridge-type connection pattern 140 while the first electrode line 110 is insulated.

According to an embodiment shown in FIG. 7, by forming the insulation pattern 130a along the lengthwise direction of the first electrode line 110, no additional insulation material needs to be coated in between the first electrode line 110 and the partial electrodes 120a, 120b, and the light transmittance can be improved because a minimum amount of insulation material is coated on the opaque first electrode line 110 and its surrounding areas.

The described insulation pattern can be any one of an insulation pattern that is flatly coated in a lengthwise direction of an electrode line passing in between severed areas, an insulation pattern that is coated in the shape of a circle or an ellipse, and an insulation pattern that is coated in the shape of an arch, of which a center portion is lifted.

In other words, in an embodiment shown in FIG. 7, the width of the insulation pattern 1301 is formed to be longer than a width d6 of the electrode 120b.

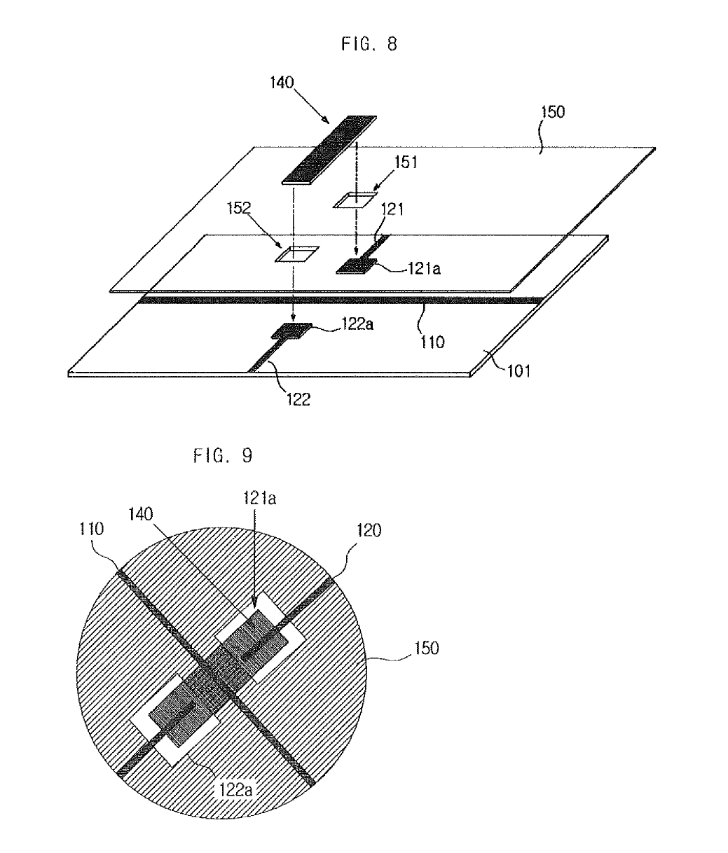

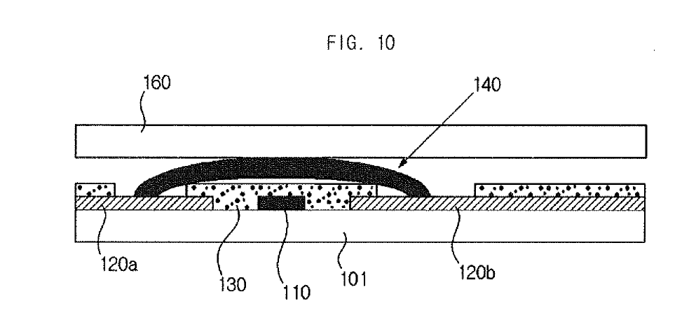

FIG. 8 and FIG. 9 are conceptual diagrams illustrating a bridge-type connection pattern in accordance with another embodiment of the present invention.

Referring to FIG. 8, the first electrode line 110 intersects with the second electrode lines 121, 122 on the transparent layer 101, and the second electrode lines form a severed area where the intersection is made so that the first electrode line 110 is not in contact with the second electrode lines 121, 122.

Here, an electrode pad 121a, 122a having a same material as the second electrode line 120 can be arranged at each end of the second electrode lines 121, 122. When the electrode pad 121a, 122a is connected with the bridge-type connection pattern 140, which is arranged nearby, through a via hole 151, 152, electrical contact with the bridge-type connection pattern 140 can be improved.

An insulation layer 150, which is made of a non-conductive film having a high light transmittance or a clear insulation material, can be arranged in between the bridge-type connection pattern 140 and the transparent layer 101. The insulation layer 150 can have the via holes 151, 152 formed therein for connection between the bridge-type connection pattern 140 and the electrode pads 121a, 122a, and the bridge-type connection pattern 140 can be connected to one side 121a and the other side 122a of a second pad through the via holes 151, 152.

According to an embodiment of the present invention, the insulation layer can be a non-conductive film layer or a clear insulation material that is arranged between the connection pattern electrically connecting the severed electrode lines and the transparent layer having the plurality of first and second electrode lines.

In other words, the connection pattern and the severed electrode lines can be electrically connected through the via holes formed in the non-conductive film layer or the clear insulation material.

That is, connection can be made through the via holes, which are formed where the bridge-type connection pattern and the severed electrode lines are electrically connected.

FIG. 9 is a front view illustrating the first electrode line 110 and the second electrode line 120 formed in a transparent pad 101 in accordance with an embodiment of the present invention.

Referring to FIG. 9, when the first electrode line 110 intersects with the second electrode line, the insulation layer 150 is formed in an entire area where the first electrode line 110 intersects with the second electrode line 120. The first electrode line 110 and the second electrode line 120 are electrically insulated from each other by the insulation layer 150, and the bridge-type connection pattern 140 can be connected along an exposed surface of the insulation layer 150 through the via holes 121a, 122a formed in the insulation layer 150.

The insulation layer can be a non-conductive film layer arranged between the bridge-type connection pattern and the transparent layer having the plurality of the first and second electrode lines formed therein.

The bridge-type connection pattern 140 is arranged on the insulation layer 150 that is flat, and thus can be realized in the shape of a plane table, unlike the embodiment shown in FIG. 3.

Moreover, in an embodiment shown in FIG. 9, the first electrode line 110 and the second electrode line 120 are electrically insulated from each other by the flat insulation layer 150, and the bridge-type connection pattern 140 is in the shape of a plane table, which means that the entire touch screen 100 can form a flat surface.

FIG. 10 is a lateral cross-sectional view of the bridge-type connection pattern 140 in accordance with an embodiment shown in FIG. 5.

Referring to FIG. 10, the touch screen 100 includes the first electrode line 110 formed on the transparent layer 101, the insulation pattern 130 insulating the first electrode line 110, the partial electrodes 120a, 120b of the second electrode line 120 arranged at either end of the insulation pattern 130 to constitute the severed area, and the bridge-type connection pattern 140 electrically connecting the partial electrodes 120a, 120b of the second electrode line 120 with each other.

The bridge-type connection pattern 140 is formed in the shape of an arch, of which the center portion is lifted by the insulation pattern 130 formed on the transparent layer 101 in order to prevent the bridge-type connection pattern 140 from making contact with the first electrode line 110, and has both ends thereof connected with the partial electrodes 120a, 120b of the second electrode line 120, allowing the first electrode 110 and the second electrode 120 to be independently connected.

In the structure shown in FIG. 10, the bridge-type connection pattern 140 can have an OCA (Optically Clear Adhesive) or a clear insulation material arranged thereon.

As described above, the touch screen using the single transparent panel 101 has the first electrode line 110 and the second electrode line 120 formed as thinly as in units of microns and thus can deliver an image projected from the display device to the user without making the user aware of the first electrode line 110 and the second electrode line 120.

Moreover, since the first electrode line 110 and the second electrode line 120 are formed on the same transparent layer 101 instead of separate sheets, the touch screen in accordance with an embodiment of the present invention can be entirely thinner, thereby becoming slimmer than the touch panel having the conventional mesh structure as well as the conventional touch panel using the light-permeable conductor (ITO).

Upon combining and testing a display device with the touch panel having a width, thickness and distance of the first electrode line 110 and the second electrode line 120 in accordance with an embodiment of the present invention, it is found that the touch panel in accordance with an embodiment of the present invention has the light transmittance of 90.08%.

Since the conventional touch screen using the light-permeable conductor (ITO) has to overlap individual sheets, in which X electrodes and Y electrodes are independently formed, over a cover glass, the light transmittance when the two sheets are overlapped becomes lower than the touch screen 100 in accordance with an embodiment of the present invention.

That is, the touch screen 100 in accordance with an embodiment of the present invention has the pair of touch electrodes 110, 120 formed on the single transparent panel 101 and thus can demonstrate a better light transmittance than the convention touch screen in which two or more films are combined.

Moreover, while in the case of the conventional mesh screen, the conventional touch screen using the light-permeable conductor needs to have the sheets, in which the X electrodes and the Y electrodes are respectively formed, overlapped on the cover glass, the touch panel in accordance with an embodiment of the present invention can form the mesh structure either underneath the cover glass or above a back light, making it possible to decrease the overall thickness and shorten the manufacturing process.

The present invention can be applied in a touch screen of a small-size (10 inches or less) portable terminal, such as a smartphone, Internet device, portable game device, tablet pad and a digital camera.

Moreover, the present invention can be applied in a mid/large-size (10 inches or bigger) display screen, such as an industrial/medical device, home automation device, all-in-one PC, notebook computer, ATM, POS, automobile, airplane, ship, information display and TV.

What is claimed is:

1. A touch screen having mesh patterned electrodes, the touch screen comprising a first electrode and a second electrode, intersecting with each other on an insulating transparent layer,
wherein the first electrode and the second electrode are an alloy of at least one selected from the group consisting of gold, silver, platinum, copper, nickel and chrome.

2. The touch screen of claim 1, wherein the insulating transparent layer is one selected from the group consisting of glass and PET, transparent film, transparent acryl and transparent plastic.

3. A touch screen having mesh patterned electrodes, the touch screen comprising:
a plurality of first electrode lines formed with metal lines in a diagonal direction on one surface of a transparent layer; and
a plurality of second electrode lines formed with metal lines on the same surface as the plurality of first electrode lines and intersecting with the first electrode lines, wherein any one electrode line of the first electrode lines and the second electrode lines forms a severed area where the plurality of first electrode lines intersect with the plurality of second electrode lines in such a way that the first electrode lines are electrically severed from the second electrode lines, and wherein the other electrode line of the first electrode lines and the second electrode lines passes through the severed area, and a step is formed at a position facing the severed area; and
a connection pattern electrically connecting the electrode lines severed by the severed area.

4. The touch screen of claim 3, further comprising an insulation layer insulating the connection pattern from the electrode line passing through the severed area.

5. The touch screen of claim 3, further comprising a plurality of sub-electrode lines formed inside an area demarcated by the plurality of first electrode lines and second electrode lines and connected to any one electrode line of the first electrode lines and the second electrode lines, the sub-electrode lines having a structure of a lattice.

6. The touch screen of claim 3, wherein a plurality of sub-electrode lines demarcated by the plurality of first electrode lines and second electrode lines and formed inside areas longitudinally facing each other are connected with the first electrode lines and severed from the second electrode lines, and
wherein a plurality of sub-electrode lines demarcated by the plurality of first electrode lines and second electrode lines and formed inside areas latitudinally facing each other are connected with the second electrode lines and severed from the first electrode lines.

7. The touch screen of claim 3, wherein a virtual axis drawn longitudinally from points where the plurality of first electrode lines and second electrode lines intersect with one another is tilted by a predetermined angle from a line forming a right angle from an upper-side line of the touch screen.

8. The touch screen of claim 7, wherein the predetermined angle is within a range of 20 degrees to the left or right.

9. The touch screen of claim 5, wherein a length of the connection pattern electrically connecting the severed electrode lines is within a range that is greater than twice and smaller than four times of a width of the lattice of the sub-electrode lines.

10. The touch screen of claim 6 wherein a thickness of the sub-electrode lines is 0.05-10 um, and a width of the sub-electrode lines is 0.5-10 um.

11. The touch screen of claim 10, wherein the sub-electrode lines are repeatedly formed at an interval of 100-2000 um to form a lattice structure.

12. The touch screen of claim 4, wherein the insulation layer has a thickness of 0.5-2 um and a width of 1-100 um.

13. The touch screen of claim 4, wherein the insulation layer is one of an insulation pattern that is flatly coated in a lengthwise direction of an electrode line passing in between the severed area, an insulation pattern that is coated in the shape of a circle or an ellipse, and an insulation pattern that is coated in the shape of an arch, of which a center portion is lifted.

14. The touch screen of claim 4, wherein the insulation layer is a non-conductive film layer or a clear insulation coating arranged in between the connection pattern electrically connecting the severed electrode lines and the transparent layer in which the plurality of first and second electrode lines are formed, and
wherein the connection pattern and the severed electrode lines are electrically connected through a via hole formed in the non-conductive film layer or the clear insulation coating.
